(19) United States
(12) Patent Application Publication
(10) Pub. No.: US 2011/0122197 A1
(43) Pub. Date: May 26, 2011

(54) INKJET HEAD AND INKJET PRINTER HAVING THE SAME

(75) Inventors: Hyun-Ho SHIN, Yongin-si (KR); Jae-Woo Joung, Suwon-si (KR); Chang-Sung Kim, Yongin-si (KR); Yoon-Sok Park, Suwon-si (KR); Ji-Han Kwon, Suwon-si (KR); Won-Chul Sim, Seongnam-si (KR); Jae-Sang Lee, Seoul (KR)

(73) Assignee: SAMSUNG ELECTRO-MECHANICS CO., LTD.

(21) Appl. No.: 12/839,684

(22) Filed: Jul. 20, 2010

(30) Foreign Application Priority Data
Nov. 25, 2009 (KR) 10-2009-0114790

(51) Int. Cl. B41J 2/14

(52) U.S. Cl. 347/47

(57) ABSTRACT

An inkjet head and an inkjet printer having the inkjet head are disclosed. In accordance with an embodiment of the present invention, the inkjet head includes a chamber housing ink and a nozzle, which discharges the ink housed in the chamber. Here, a plurality of inner wall grooves are formed on an inner wall of the nozzle, in which the plurality of inner wall grooves extends in a lengthwise direction of the nozzle. Thus, the inkjet head can discharge big ink droplets at a high frequency by quickly filling the ink in the nozzle after relatively big ink is discharged.

### CROSS-REFERENCE TO RELATED APPLICATIONS

This application claims the benefit of Korean Patent Application No. 10-2009-0114790, filed with the Korean Intellectual Property Office on Nov. 25, 2009, the disclosure of which is incorporated herein by reference in its entirety.

### BACKGROUND

1. Technical Field

The present invention is related to an inkjet head and an inkjet printer having the inkjet head.

2. Description of the Related Art

An inkjet printer is an apparatus for discharging droplets of ink through a nozzle by transforming an electric signal to a physical force.

The inkjet printer is equipped with an inkjet head for discharging the droplets of ink, and the inkjet head may be manufactured by forming different components, such as a chamber, a restrictor, a nozzle and a piezoelectric body, in several layers and stacking these layers on one another.

During a continuous droplet ejection, the additional supply of ink through a restrictor should be equal to the amount of ink droplet ejected at the nozzle. Here, the ink is relatively slowly supplied because of the resistance of the restrictor. If the discharged droplet is bigger, the refilling time will be much longer.

Therefore, in an inkjet head that aims to discharge droplets of a relatively bigger size (e.g., >80 pL), the refill rate of the ink becomes an important factor in determining the frequency of discharging the ink.

In addition, the straightness of the discharged ink is an important factor in the printing quality of the inkjet printer.

### SUMMARY

The present invention provides an inkjet head and an inkjet printer having the inkjet head that can discharge a big droplet at a high frequency. The present invention also provides an inkjet head and an inkjet printer having the inkjet head that improves the straightness of a droplet.

An aspect of the present invention provides an inkjet head that includes a chamber housing ink and a nozzle, which discharges the ink housed in the chamber. Here, a plurality of inner wall grooves are formed on an inner wall of the nozzle, in which the plurality of inner wall grooves extends in a lengthwise direction of the nozzle.

The plurality of inner wall grooves can be radially disposed on the inner wall of the nozzle.

The plurality of inner wall grooves can be symmetrically formed about a center of the nozzle.

The plurality of inner wall grooves formed on the inner wall of the nozzle can be concavo-convex curves continuously formed along the inner wall of the nozzle.

The plurality of inner wall grooves can be formed to penetrate from the inside to the outside of the chamber.

The inkjet head can further include a piezoelectric body, which provides pressure to the chamber.

Another aspect of the present invention provides an inkjet printer that includes an inkjet head and an ink supplying unit, which supplies ink to the inkjet head.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a cross-sectional view of an inkjet head in accordance with an embodiment of the present invention.

FIG. 2 is a perspective view of an inkjet head in accordance with an embodiment of the present invention.

FIG. 3 shows some examples of the shape of a nozzle in an inkjet head in accordance with an embodiment of the present invention.

FIGS. 4 and 5 compare the results of an inkjet head in accordance with the related art and an inkjet head in accordance with an embodiment of the present invention.

### DETAILED DESCRIPTION

The features and advantages of this invention will become apparent through the below drawings and description.

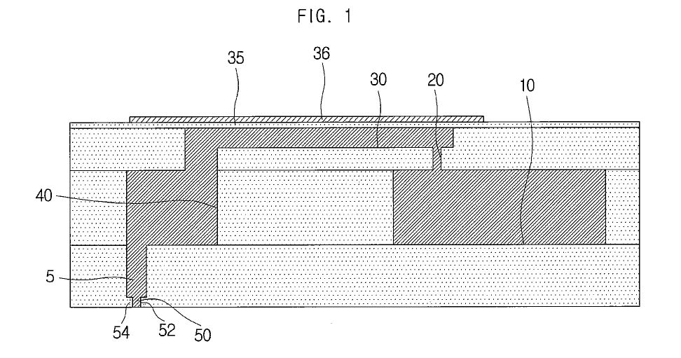

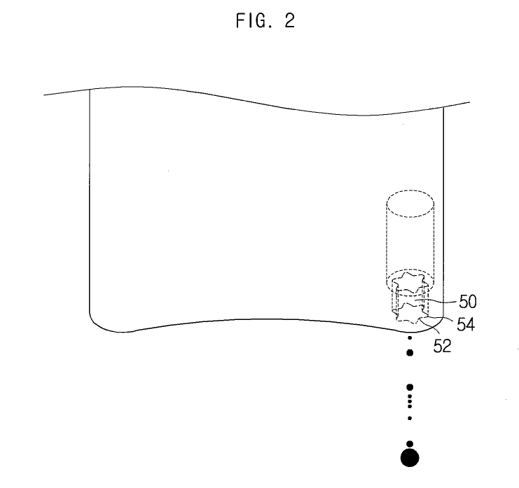

FIG. 1 is a cross-sectional view of an inkjet head in accordance with an embodiment of the present invention, and FIG. 2 is a perspective view of an inkjet head in accordance with an embodiment of the present invention.

The inkjet head in accordance with an embodiment of the present invention includes a chamber 30 and a nozzle 50 having a plurality of inner wall grooves 54 formed thereon. The inkjet head can include a reservoir 10, a restrictor 20, the chamber 30, a damper 40, a membrane 35 and a piezoelectric body 36.

The chamber 30 is where ink is contained, and once pressure is applied by, for example, the piezoelectric body 36 formed on an upper surface of the membrane 35, the ink can be moved in a direction of the nozzle 50 for discharge. A plurality of chambers 30 can be disposed in parallel in a single inkjet head, and there can be a matching number of piezoelectric bodies 36 to the number of chambers 30 in order to provide pressure to each of the plurality of chambers 30. Here, the piezoelectric bodies 36 are separated from one another so that the piezoelectric body 36 corresponding to a chamber 30 minimally influences adjacent chambers 30. Also, an upper electrode (not shown) and a lower electrode (not shown) can be respectively formed on top and bottom of the piezoelectric body 36 in order to supply a voltage to the piezoelectric body 36.

The reservoir 10 is supplied with ink from an ink supplying unit (not shown) through an inlet, stores the ink and provides the ink to the chamber 30. Here, various known ink supplying devices can be used as the ink supplying unit to supply the ink to the inkjet head.

The restrictor 20 links the reservoir 10 with the chamber 30 and can function as a channel controlling the flow of ink between the reservoir 10 and the chamber 30. For this, the restrictor 20 is formed to have a smaller sectional area than those of the reservoir 10 and the chamber 30 so that the restrictor 20 can control the amount of ink supplied to the chamber 30 from the reservoir 10 when the membrane 35 is vibrated by the piezoelectric body 36.

The nozzle 50 is connected to the chamber 30 and discharges the ink supplied from the chamber 30. When the vibration generated by, for example, the piezoelectric body 36 is supplied to the chamber 30 through the membrane 35, pressure can be applied to the chamber 30, causing the nozzle 50 to discharge the ink. Here, the damper 40 can be interposed between the chamber 30 and the nozzle 50. The damper 40 can converge the energy generated by the chamber 30 toward the nozzle 50 and dampen a rapid change in pressure.

Particularly, in accordance with an embodiment of the present invention, a plurality of inner wall grooves 54 extended in a lengthwise direction of the nozzle 50 can be formed in an inner wall 52 of the nozzle 50, and thus the nozzle 50 can be quickly filled with newly supplied ink after discharging the ink.

Specifically, a plurality of inner wall grooves 54 penetrating from the inside to the outside of the chamber 30 can be formed in the inner wall 52 of the present embodiment so that the interfacial circumference of the ink can be increased. Accordingly, the amount of surface tension force of the ink that is in contact with the inner wall 52 of the nozzle 50 can be increased, and thus this reinforced surface tension force pulls the meniscus towards the exit of nozzle 50 more strongly. This can allow the ink to be quickly filled along the inner wall 52 of the nozzle 50.

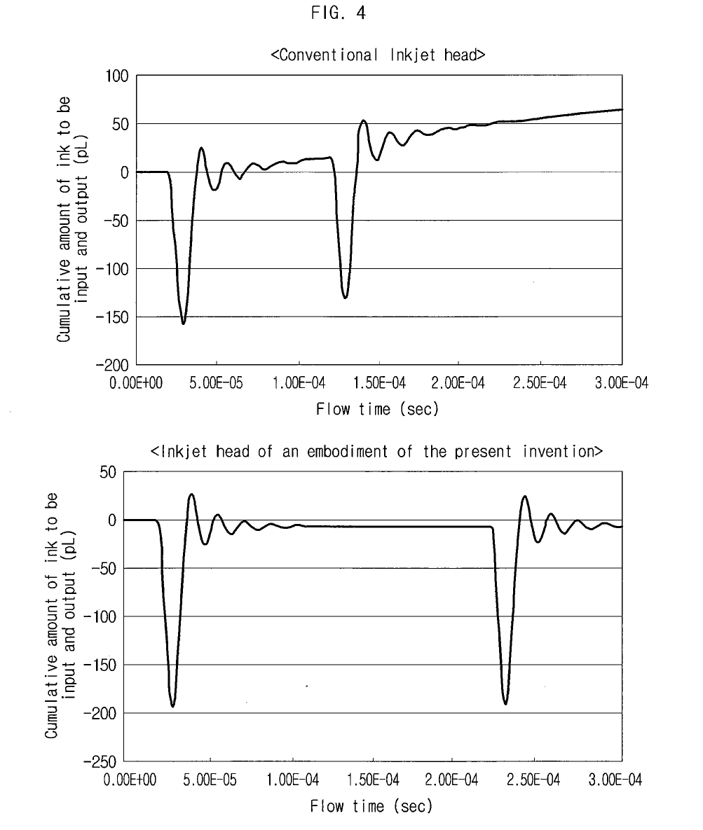

Accordingly, the nozzle 50 having the inner wall grooves 54 formed therein can be quickly filled with ink after the ejection of big ink droplet whose volume is higher than 80 pL. Therefore, as illustrated in FIG. 4, the inkjet head of the present embodiment can uniformly discharge big ink droplets at a high frequency, compared to the conventional inkjet head. Since the conventional inkjet head is not capable of filling the ink at a fast rate, the amount of ink to be output becomes smaller than that of ink to be input. That is, the discharged droplets of ink gradually become smaller, However, the inkjet head of the present embodiment can steadily input and output the ink even at a high frequency, and thus big ink droplets can be discharged relatively constantly.

In this embodiment, since the plurality of inner wall grooves 54 form concavo-convex curves continuously along the inner wall 52 of the nozzle 50, the interfacial circumference of the ink can be maximized.

In order to form a uniform interface along the inner wall 52 of the nozzle 50, the plurality of inner wall grooves 54 on the inner wall 52 of the nozzle 50 can be radially disposed.

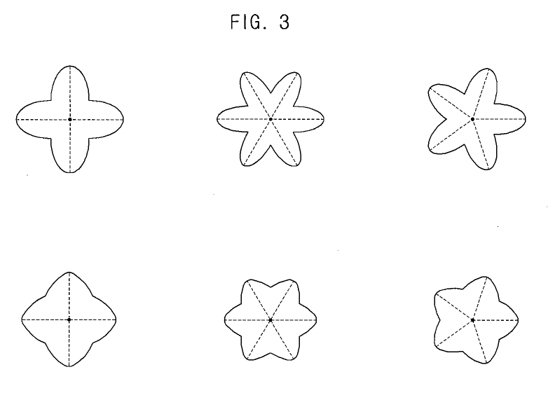

FIG. 3 shows some examples of the shape of the nozzle 50 in an inkjet head in accordance with an embodiment of the present invention.

However, during the manufacturing processes, the sharp concave corners of circumference of the nozzle 50 can be little bit blunted or rounded. For example, a printhead fabricated by silicon MEMS processes, a mask of silicon wafer is designed like the shape of FIG. 3. But during a Deep RIE (Reactive Ion Etching) process, the sharp concave corner will be collapsed into rather rounded corner.

As illustrated in FIG. 3, by forming the plurality of inner wall grooves 54 in a radial shape (that is, a shape similar to a star), the inner wall grooves 54 can be formed uniformly along the inner wall 52 of the nozzle 50. Accordingly, the surface tension filling the ink can act uniformly on the inner wall 52, and the circumference of the inner wall 52 of the nozzle 50 can be greatly increased, compared to that of the conventional circular nozzle. Therefore, the area of the interfacial circumference of the ink formed along the circumference of the inner wall grooves 54 increases, and thus the strength of the surface tension acting on the interfacial circumference increases. The enhanced strength of the surface tension on the interfacial circumference can steadily control an unstable behavior of the interfacial circumference of the ink caused by a minute change in pressure inside the damper 40, and the interfacial circumference of the ink can be steadily adhered to the inner wall 52 of the nozzle 50, thus improving the straightness of the discharged droplet.

Particularly, by forming the plurality of inner wall grooves 54 symmetrically about the center of the nozzle 50, a symmetrical interfacial circumference can be formed about the center of an ink droplet, and thus the straightness of the discharged ink can be improved.

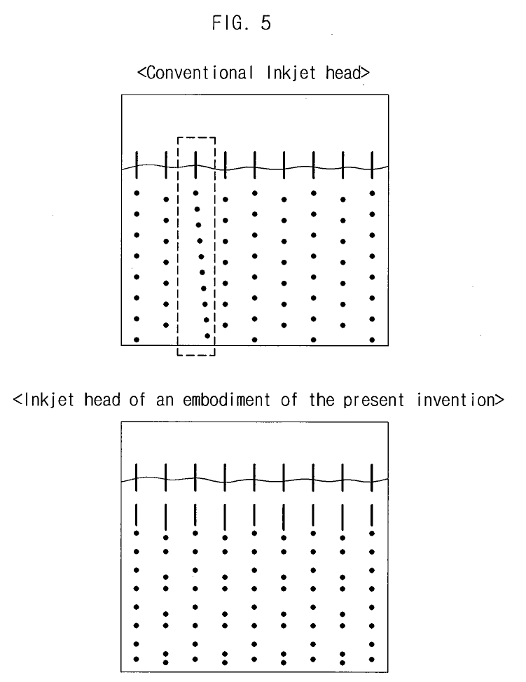

As illustrated in FIG. 5, ink droplets are often discharged in a diagonal direction in the conventional inkjet head, due to the pressure imbalance of the damper 40. In the inkjet head of the present embodiment, however, the inner wall grooves 54 are symmetrically formed about the center of the nozzle 50 so that the interfacial circumference that is symmetrical about the center of an ink droplet can be widely formed. As a result, the interfacial circumference of an ink droplet can be steadily adhered to the inner wall 52 of the nozzle 50, and thus the interfacial circumference can be maintained consistent even though a certain degree of pressure imbalance occurs, thereby improving the straightness of the discharged ink.

Meanwhile, an additional ink supplying unit for supplying ink can also be included in the inkjet head of the present embodiment to form an inkjet printer.

According to an embodiment of the present invention, large-size ink droplets can be discharged at a high frequency by quickly filling the ink in a nozzle after the large-size ink droplets are discharged.

Furthermore, the straightness of the discharged ink droplets can be improved by making the interfacial circumference of the ink droplet uniform.

While the spirit of the present invention has been described in detail with reference to a particular embodiment, the embodiment is for illustrative purposes only and shall not limit the present invention. It is to be appreciated that those skilled in the art can change or modify the embodiment without departing from the scope and spirit of the present invention.

As such, many embodiments other than that set forth above can be found in the appended claims.

What is claimed is:

1. An inkjet head comprising:
a chamber housing ink; and
a nozzle configured to discharge the ink housed in the chamber,
wherein a plurality of inner wall grooves are formed on an inner wall of the nozzle, the plurality of inner wall grooves extending in a lengthwise direction of the nozzle.

2. The inkjet head of claim 1, wherein the plurality of inner wall grooves are radially disposed on the inner wall of the nozzle.

3. The inkjet head of claim 2, wherein the plurality of inner wall grooves are symmetrically formed about a center of the nozzle.

4. The inkjet head of claim 1, wherein the plurality of inner wall grooves formed on the inner wall of the nozzle are concavo-convex curves continuously formed along the inner wall of the nozzle.

5. The inkjet head of claim 1, wherein the plurality of inner wall grooves are formed to penetrate from the inside to the outside of the chamber.

6. The inkjet head of claim 1, further comprising a piezoelectric body configured to provide pressure to the chamber.

7. An inkjet printer comprising:
an inkjet head in accordance with any one of claims 1 to 6; and
an ink supplying unit configured to supply ink to the inkjet head.
